(19) United States
(12) Patent Application Publication
(10) Pub. No.: US 2010/0203475 A1
(43) Pub. Date: Aug. 12, 2010

(54) Tooth implant device and flexible fixture used therein

(75) Inventors: Yong San Yoon, Daejon (KR); Jae Yeol Jung, Daejon (KR)

Correspondence Address: BACON & THOMAS, PLLC, 625 SLATERS LANE, FOURTH FLOOR, ALEXANDRIA, VA, 22314-1176, US

(73) Assignee: KOREA ADVANCED INSTITUTE OF SCIENCE AND TECHNOLOGY, Daejon (KR)

(21) Appl. No.: 12/659,044

(22) Filed: Feb. 24, 2010

(30) Foreign Application Priority Data
Feb. 12, 2009 (KR) 10-2009-0011271

(51) Int. Cl. A61C 8/00

(52) U.S. Cl. 433/173

(57) ABSTRACT

A tooth implant device comprises an abutment and a fixture. The abutment includes an upper portion to which a dental crown is attached and a lower portion whose cross-section decreases to a downward direction. The fixture includes an abutment inserting hole into which the abutment is inserted and is made of a bone-friendly metallic material. The fixture has an outer surface without threaded portions and has stiffness in a range of 5 percents to 40 percents compared to that of a solid form. When the abutment is inserted into the abutment inserting hole, the flexible fixture expands to apply a uniform stress to alveolar bone and be secured thereto in a taper-lock fashion.

### TECHNICAL FIELD

The present invention relates to a tooth implant device, and more particularly, to a tooth implant device that includes an abutment in which a crown acting as a tooth is installed and a fixture made of a metallic material, the fixture not having a threaded portion on the outer peripheral surface thereof and having a stiffness smaller than that of a solid form such that the flexible fixture expands when the abutment is inserted, applying a uniform stress to the peripheral osseous tissues of the tooth so as to fix the fixture in a taper-lock fashion.

### BACKGROUND ART

In general, a tooth implant device includes a fixture fixedly inserted into an alveolar bone and an abutment a lower portion of which is inserted into the fixture and to which a crown having a tooth-like shape is attached at an upper portion thereof. In a medical procedure using such a tooth implant device, a lower portion of an abutment is inserted into a fixture after the fixture is fixed to the alveolar bone, and a crown, i.e. an artificial tooth is bonded to an upper portion of the abutment.

A screw thread is mainly used to fix a fixture to an alveolar bone. For this purpose, a threaded portion is formed on the outer peripheral surface of the fixture, and the fixture is fixedly inserted into a hole formed in the alveolar bone using the threaded portion. However, it is reported that, when a fixture is implanted by using a threaded portion, the amount of osseous tissues around the implanted fixture is reduced and degraded. This is caused by the fact that the stress applied to the osseous tissues adjacent to the fixture is non-uniformly distributed. The tissues of the alveolar bone into which the fixture is inserted include a cortical bone portion and a trabecular bone portion which have different strengths each other. When a fixture is inserted into the alveolar bone, the cortical bone portion is under greater stress than the trabecular bone portion since the former has a relatively higher strength than the latter. Furthermore, the threaded portion formed on the outer peripheral portion of the fixture has a thread and a groove, and a local difference in stress concentration appears between the thread and the groove. Such local difference in stress concentration leads to resorption in alveolar bone and degraded bone tissues.

According to Wolff's law known to coincide with the actual phenomenon, bone would grow up if a stress applied to bone tissue increase within a physiological limit, a bone would be resorbed if the stress applied to bone tissues exceeds the physiological limit and increases extremely. In a tooth implant device using a fixture having a threaded portion, if a load is applied to a crown when, for example, chewing food, a stress higher than a physiological limit may be applied to the bone tissues around screw threads to cause bone resorption. Additionally, a stress in the bone tissues around the screw grooves may be reduced to cause bone resorption. Thus, a tooth implant device using a threaded portion tends to cause bone resorption when it is used for a long time.

Korean Patent No. 749,787 of the applicant discloses a device which fixes a fixture not using a threaded portion but being fixed into a bone tissue in a taper-lock fashion, in order to solve the above-mentioned problems of a conventional tooth implant device in which a fixture is fixed using a threaded portion. The implant device includes a fixture which does not have a threaded portion on the outer peripheral surface thereof and is made of a soft material such as an engineering plastic. Therefore, when an abutment is inserted into the fixture, a uniform stress is applied to an alveolar bone around the fixture. However, since the engineering plastic used for the material of the fixture has a low bone affinity as compared with widely used materials such as titanium, the growth of bone tissues around the fixture becomes delayed and the fixture would not be readily fixed. Moreover, although bone-friendly particles are coated on a surface of the fixture made of an engineering plastic to increase bone affinity, the particles may be separated from the surface of the fixture due to impacts to the particles over time.

### DETAILED DESCRIPTION OF THE INVENTION

In order to solve the aforementioned problems, an object of the present invention is to provide a tooth implant device whose fixture is secured to alveolar bone by using taper-lock operation and made of bone-friendly material.

According to an aspect of the present invention, there is provided a tooth implant device comprising: an abutment including an upper portion to which a dental prosthetic is attached and a lower portion whose cross-section decreases to a downward direction; and a fixture including an abutment inserting hole whose cross-section decreases to a downward direction corresponding to the lower portion of the abutment and into which the abutment is inserted, the fixture being made of a bone-friendly metallic material, wherein the fixture has an outer surface being without threaded portions and contacting with alveolar bone, and wherein the fixture is fabricated to have a stiffness in a range of 5 percents to 40 percents compared to that of a solid form, whereby, when the abutment is inserted into the abutment inserting hole, the fixture expands to apply a uniform stress to alveolar bone and be secured thereto in a taper-lock fashion.

According to another aspect of the present invention, there is provided a fixture which is to be used in a tooth implant device and is made of a bone-friendly metal, the fixture comprising: an abutment inserting hole whose cross-section decreases to a downward direction and into which an abutment is inserted; an outer surface being without threaded portion and contacting with alveolar bone; and, a body having a plurality of pores, the pores making the body to have a stiffness in a range of 5 percents to 40 percents compared to that of a solid form, whereby, when the abutment is inserted into the abutment inserting hole, the body expands to apply a uniform stress to alveolar bone and be secured thereto in a taper-lock fashion.

### BRIEF DESCRIPTION OF THE DRAWINGS

FIG. 1 is a view schematically illustrating a tooth implant device according to the present invention;

FIG. 2 is a view illustrating an assumption that an alveolar bone is made of the same material as that of a fixture in the tooth implant device of FIG. 1;

FIG. 3 is a view illustrating a state in which pores are arranged in a staggered 60 degree pattern in a porous object; and

FIG. 4 is a view illustrating a relationship between the stiffness of the porous object of FIG. 3 and porosity.

### BEST MODE FOR CARRYING OUT THE INVENTION

Hereinafter, an exemplary embodiment of the present invention will be described in detail with reference to the accompanying drawings.

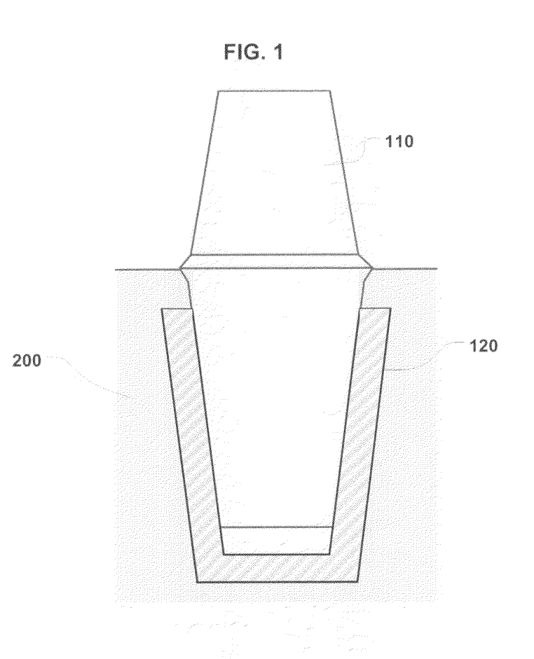

As illustrated in FIG. 1, the tooth implant device according to the present invention includes an abutment 110 to which a tooth-shaped crown is attached at an upper portion thereof and a fixture 120 made of a metallic material having a high bone affinity. The fixture 120 does not include any threaded portion on the outer surface thereof, and when the abutment 110 is inserted into the fixture 120, it expands radially to be fixed in a taper-lock fashion and applies a uniform stress to the peripheral alveolar bone 200.

In order to generate a taper-lock operation, the frictional force between the outer peripheral surface of the fixture 120 and the alveolar bone 200 needs to be greater than that between the abutment 110 and the fixture 120. However, since the fixture 120 is made of a metallic material having the same stiffness as that of titanium, a taper-lock operation would not be not be generated even when the abutment 110 is inserted if the fixture 120 is in a solid form. In order to generate a taper-lock operation when using the fixture 120 made of a metallic material, the strength of the fixture 120 needs to be smaller than that of a fixture in a solid form. Throughout the specification, the term “a solid form” means that the interior of an object is fully filled with the material consisting of the object. Therefore, it is understood that an object is not in a solid form when a plurality of pores are formed within the object and the object has empty spaces filled with a stuff other than the material consisting of the object.

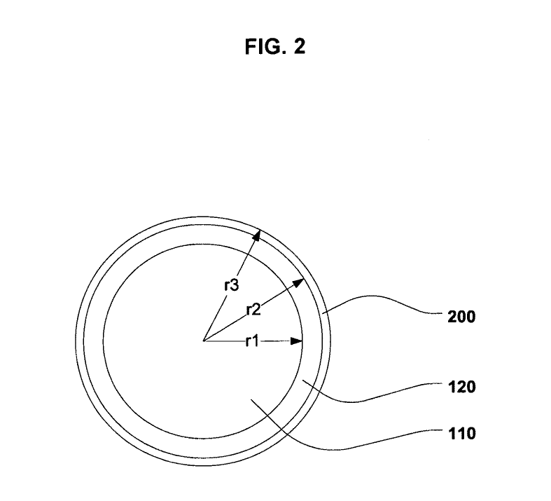

FIG. 2 schematically illustrates a cylindrical object having radii of r1, r2, and r3, i.e., the radii of the abutment 110, the fixture 120, and the peripheral bone tissues, respectively. The peripheral bone tissues may be considered to have an equivalent radius r3 under the assumption that they are made of the same material as that of the fixture 120. In this case, the relationship can be expressed as in Equation 1.

$${P}_{2} = \frac{{r}_{1}^{2}}{{r}_{2}^{2}} \frac{{r}_{3}^{2} - {r}_{2}^{2}}{{r}_{3}^{2} - {r}_{1}^{2}} {P}_{1} \qquad [ Equation 1 ]$$

where, P₁ is a pressure applied to the fixture 120 by the abutment 110 and P₂ is a pressure applied to the bone tissues 200 by the fixture 120.

From above relationship, given that the frictional coefficient between the abutment 110 and the fixture 120 is μ₁ and the frictional coefficient between the fixture 120 and the bone tissues is μ₂, the frictional force per unit area between the abutment 110 and the fixture 120 and the frictional force per unit area between the fixture 120 and the bone tissues 200 are as follows.

F₁=μ₁P₁

F₂=μ₂P₂ [Equation 2]

In order to ensure a taper-lock operation, the frictional force F₁ between the abutment 110 and the fixture 120 should be smaller than the frictional force F₂ between the fixture 120 and the bone tissues 200. However, since the surface area A1 of the abutment 110 is smaller than the surface area A2 of the fixture 120, the frictional force over the entire area may be greater between the fixture 120 and the bone tissues even when the frictional forces per unit area F₁ and F₂ are equal to each other.

If general dimensions of a tooth implant device are applied to the radii r₁ and r₂ of FIG. 2, the radius r₁ of the abutment 110 becomes 1.5 mm and the radius r₂ of the fixture 120 1.8 mm. Here, the fixture 120 is in a solid form. If the material of the fixture 120 is determined, the equivalent radius r₃ of the bone tissues may be obtained. As a typical example, if the fixture 120 is made of titanium, the equivalent radius r₃ of the titanium bone tissues becomes 1.87 mm.

In the conventional tooth implant device, the frictional coefficient between the abutment 110 and the fixture 120 is approximately 0.2. Although the frictional coefficient between the fixture 120 and the bone tissues would be changed according to the material and surface condition of the fixture 120, it is known to be greater than about 0.5 when the fixture 120 is made of titanium.

Thus, if the frictional coefficients μ₁ and μ₂ are 0.2 and 0.5 respectively and the radii r₁, r₂, and r₃ have above-mentioned values, a relationship of P₂=0.14P₁ is established from Equation 1. From Equation 2, it can be seen that F₁ has a value of 0.2P₁ and F₂ has a value of 0.07P₁. That is, when the fixture is made of titanium in a solid form, the frictional force between the abutment 110 and the fixture 120 would be about three times the frictional force between the fixture 120 and the bone tissues 200 and thus a taper-lock operation would not established.

Next, a case in which the stiffness of the fixture 120 is smaller than that of a fixture in a solid form according to the present invention will be explained. In this embodiment, the stiffness of the fixture 120 is 20% of that of a fixture in a solid form. An equivalent radius of the fixture 120 is as a radius of a fixture that is in a solid form and has the same stiffness, which becomes 1.56 mm. Likewise, the radius of the bone tissues becomes 1.63 mm when it is considered made of titanium. From Equation 1, the relationship of P₂=0.52P₁ is established and, when the frictional coefficients are 0.2 and 0.5 respectively, F₁ becomes 0.2 P₁ and F₂ 0.26P₁. That is, the frictional force between the fixture 120 and the bone tissues is greater than the frictional force between the abutment 110 and the fixture 120. If the inner surface of the abutment insert hole of the fixture 120 is smoothly machined or coated with plastic materials, the frictional coefficient μ₁ may decrease to 0.1. In this case, F₁ reaches 0.1P₁ which is smaller than F₂. As mentioned above, it can be seen that, even when the fixture 120 is made of a metallic material such as titanium, if its stiffness is smaller than that of a fixture in a solid form, a taper-lock operation can be established. The fixture 120 according to the present invention may have a stiffness approximately 5% to 40% of that of a fixture in a solid form. As a method for decreasing stiffness without changing the material of the fixture 120, the mechanical structure of the fixture 120 may be modified to another form instead of a solid form. In the present embodiment of the invention, a plurality of pores may be formed to decrease stiffness. However, as can be seen in FIG. 4, even if the porosity of the fixture 120 increases, it is not easy to decrease the stiffness of the fixture 120 to a value less than 5% of that of a solid form. Meanwhile, the frictional coefficient between the fixture 120 and the bone tissues has different values according to conditions such as the material or the state of the outer peripheral surface of the fixture 120 and is known to have a value between approximately 0.5 and 1.0. The frictional coefficient between the abutment 110 and the fixture 120 also becomes different according to the material of the abutment 110 and the surface state of the abutment insert hole, but may be approximately 0.1 to 0.2. When the frictional coefficients are within such range, even if the stiffness of the fixture 120 has a value of approximately 40% of that of a solid form, a taper-lock operation may be achieved. When the stiffness of the fixture 120 is greater than the above-mentioned values, it is considered that a taper-lock operation may be achieved only if the frictional coefficients have extreme values.

In order for the fixture 120 to have a stiffness smaller than that of a solid form, a plurality of pores are formed in the fixture 120 in the present embodiment of the invention.

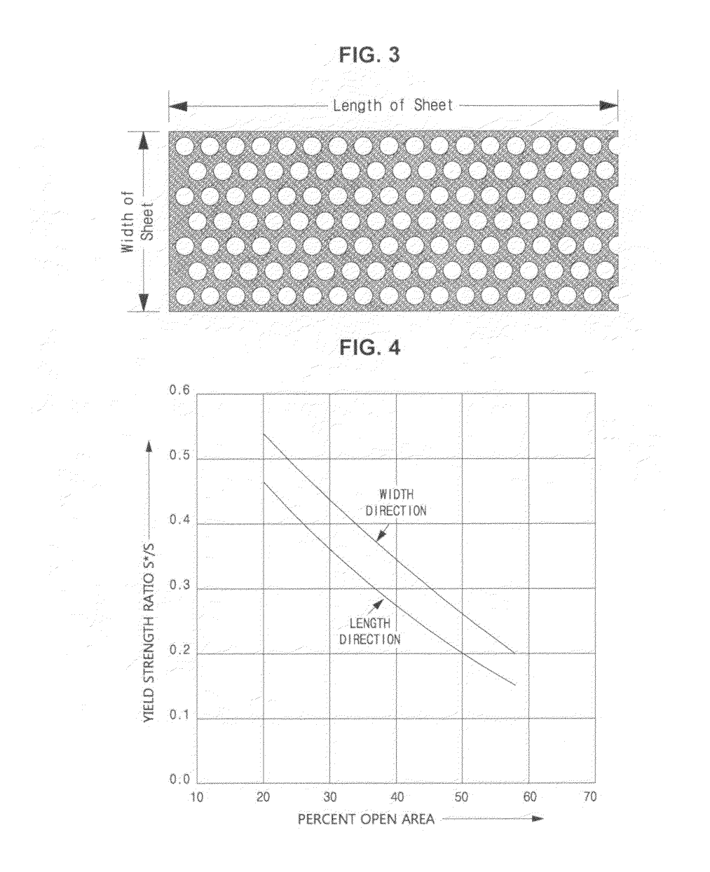

FIG. 3 illustrates a perforated material having cylindrical pores arranged in a staggered 60° pattern. The staggered 60° pattern is the most common arrangement, since the stiffness of the material is maintained high while the area of openings of pores is wide. In order to evaluate the effect of pores, the equivalent strength S* of the perforated material may be expressed as a function of the strength S of a non-perforated material. The stiffness of the perforated material has different values according to directions. In the arrangement illustrated in FIG. 3, a lengthwise direction refers to a direction in which pores are linearly arranged adjacent to each other and a widthwise direction refers to a direction in which pores are arranged in a staggered pattern. The stiffness in the widthwise direction is greater than that in the lengthwise direction.

FIG. 4 shows the stiffness of a perforated material having pores of staggered 60° pattern as shown in FIG. 3 in the widthwise and lengthwise direction. The perforated material has maximum stiffness in the lengthwise direction and minimum stiffness in the widthwise direction. As shown in FIG. 4, when a perforated material has a porosity of 50%, the stiffness in the lengthwise direction becomes a value equal to about 20% of that of a solid material. In view of the stiffness in the lengthwise direction, a perforated material has stiffness equal to 40% of a solid material when porosity thereof is 25% and 5% when 65%.

By utilizing above-mentioned physical characteristics of a perforated material, stiffness of a fixture 120 made of a metallic material can be lowered. For example, a fixture 120 with a porosity of 50% will have stiffness equal to 20% of that of a fixture in a solid form. The fixture 120 has pores arranged in a staggered 60° pattern as shown in FIG. 3 and the peripheral direction of the fixture 120 becomes the lengthwise direction of the arrangement of the pores. If the peripheral direction of the fixture 120 is corresponds to the widthwise direction of the arrangement of the pores, the fixture 120 should have a porosity of 57% in order to have a same stiffness.

Pores may be fabricated on the fixture 120 by using, e.g., laser fabrication method. It would be preferable that pores are extended from the outer surface to the inner surface of abutment insert hole. Openings of pores, for example, may has a diameter of about 0.3 mm when the abutment 110 has a diameter of about 3.0 mm and the fixture about 3.8 mm.

Meanwhile, stiffness of a perforated material in the above explanation is applied to a material having pores perforating the material. However, a fixture 120 according to the present invention may also have pores not perforating the same. If a fixture has perforating pores, foreign substances such as particles of food may migrate to bone tissue through perforating pores via abutment insert hole. If pores are not perforating the fixture 120, stiffness of the fixture will be increased than the values shown in FIG. 4. Therefore, in order for a fixture with pores not perforating the same to have a same stiffness as a fixture with perforating pores, porosity of the former should be larger than that of the latter. If pores are extended to an area near to the inner surface of abutment inserting hole, the fixture would have a required stiffness without increasing porosity thereof largely. It would be preferable that the abutment inserting hole has a smooth surface in order to lower the friction coefficient between the abutment 110 and the fixture 120 for encouraging taper-lock operation of the device.

When pores of a fixture are fabricated to perforate the same, it would be preferable that the abutment inserting surface is coated with a material such as plastic in order to prevent corruption of bone tissue from foreign materials migrated through perforating pores. Since materials such as plastic have low stiffness, the fixture 120 can have a required low stiffness without increasing porosity thereof largely. Furthermore, if the material for coating has low friction coefficient, friction force between the fixture 120 and abutment 110 decreased, which encouraging taper-lock operation of the device.

Relationship as shown in FIG. 4 can be applied to a perforated material made of any materials, including metallic materials such as titanium. Therefore, even when the fixture is made of titanium, the above-mentioned explanations are still valid. Material that forming the fixture 120 would not be restricted to any specific materials but biologically stable materials such as tantalum or titanium or an alloy thereof may be preferable.

According to an embodiment of the present invention, the fixture may be manufactured as a porous sintered body by using laser sintering method in order to lower the stiffness of the fixture without changing material forming the same. Laser sintering method is a manufacturing technique that uses a high power laser to fuse small particles of metal onto a surface of a body. By adjusting the size of particles, scanning speed of laser or scanning method thereof, a porous sintered body having a required stiffness can be manufactured.

In the aforementioned embodiments, there is risks of corruption of bone tissue from foreign materials migrated though perforated pores. In order to prevent such risks, the outer surface of the fixture may be coated. It would be preferable that coating has a lower stiffness than that of the metallic material consisting of the fixture. In such case, stiffness of the fixture does not increased largely by the coating and taper-lock operation of the fixture 120 can be maintained. Another method for preventing corruption from foreign materials, at least parts of pores may be filled with antibiotic. Furthermore, in order to enhancing growth of alveolar bone, at least parts of pores of the fixture may be filled with bone-friendly materials. Such bone-friendly materials are enhancing growth of alveolar bone near the pore filled with the same and facilitate bonding of fixture 120 and bone tissues.

In the aforementioned embodiments, the outer surface of the fixture may surface-treated in order to increase bio-compatibility. Various surface treatment methods such as anodic oxidation method, plasma oxidation method, plasma cleansing method, or vapor cleansing method may be used. Among these methods, anodic oxidation method is the process of creating a layer on a surface.

In this method, a dense and porous oxide layer can be formed using anodic spark oxidation on the surface and hydroxyapatite crystals were formed on the surface via a hydrothermal treatment. An electrolyte contains phosphate salt and Calcium ion may be used. According to recent study, bone-implant bonding was found increased in an implant device having surfaces treated by anodic spark oxidation than one having surfaces of mechanical treatments

While the present invention has been particularly shown and described with reference to exemplary embodiments thereof, it will be understood by those skilled in the art that various changes in form and details may be made therein without departing from the spirit and scope of the invention as defined by the appended claims.

1. A tooth implant device comprising:
an abutment including an upper portion to which a dental crown is attached and a lower portion whose cross-section decreases to a downward direction; and
a fixture including an abutment inserting hole whose cross-section decreases to a downward direction corresponding to the lower portion of the abutment and into which the abutment is inserted, the fixture being made of a bone-friendly metallic material,
wherein the fixture has an outer surface being without threaded portions and contacting with alveolar bone, and wherein the fixture is fabricated to have a stiffness in a range of 5 percents to 40 percents compared to that of a solid form, whereby, when the abutment is inserted into the abutment inserting hole, the fixture expands to apply a uniform stress to alveolar bone and be secured thereto in a taper-lock fashion.

2. The tooth implant device according to claim 1, wherein the fixture is made of tantalum or titanium or alloys thereof.

3. The tooth implant device according to claim 1, wherein the fixture has a plurality of pores extending from the outer surface of the fixture to an inward direction and has porosity in a range of 20 percents to 80 percents.

4. The tooth implant device according to claim 1, wherein the fixture has a porous sintered body made of a bone-friendly metal.

5. The tooth implant device according to claim 4, wherein the fixture is fabricated by laser sintering method.

6. A fixture which is to be used in a tooth implant device and is made of a bone-friendly metal, the fixture comprising:
an abutment inserting hole whose cross-section decreases to a downward direction and into which an abutment is inserted;
an outer surface being without threaded portion and contacting with alveolar bone; and
a body having a plurality of pores, the pores making the body to have a stiffness in a range of 5 percents to 40 percents compared to that of a solid form, whereby, when the abutment is inserted into the abutment inserting hole, the body expands to apply a uniform stress to alveolar bone and be secured thereto in a taper-lock fashion.

7. The fixture according to claim 6, wherein the bone-friendly metal is tantalum or titanium or alloys thereof.

8. The fixture according to claim 6, wherein porosity of the pores is in a range of 20 percents to 80 percents.

9. The fixture according to claim 6, wherein the pores extend to an inward direction from the outer surface to a surface of the abutment inserting hole.

10. The fixture according to claim 9, further comprising:
an inner coating layer applied on the surface of the abutment inserting hole, the coating being made of a material having a friction coefficient lower than that of the bone-friendly metal.

11. The fixture according to claim 6, wherein the pores extend to an inward direction from the outer surface to an area near a surface of the abutment inserting hole.

12. The fixture according to claim 11, wherein the surface of the abutment inserting hole is surface-treated so as that friction force between the outer surface and alveolar bone become greater than that between an outer surface of the abutment and the surface of the abutment inserting hole.

13. The fixture according to claim 6, wherein the body is a sintered mass having a plurality of pores.

14. The fixture according to claim 13, wherein the sintered mass is fabricated by using laser sintering method.

15. The fixture according to claim 6, wherein at lease parts of the pores are filled with antibiotic.

16. The fixture according to claim 6, wherein at lease parts of the pores are filled with bone-friendly material for enhancing grow of bone.

17. The fixture according to claim 6, further comprising:
an outer coating layer applied on the outer surface of the body for preventing the pores from being exposed.

18. The fixture according to claim 6, wherein the stiffness of the body at a portion contacting with a cortical bone is greater than that at a portion contacting with a trabecular bone.

19. The fixture according to claim 6, wherein an outer surface of the body treated by using anodic oxidation method.
